(19) United States
(12) Patent Application Publication
(10) Pub. No.: US 2025/0262775 A1
(43) Pub. Date: Aug. 21, 2025

(54) GRIPPING DEVICE

(71) Applicant: Panasonic Holdings Corporation, Osaka (JP)

(72) Inventors: SHOHEI TANIGUCHI, Osaka (JP); HIROKI IKEUCHI, Osaka (JP); HIDEKAZU ARAKI, Osaka (JP); YASUNAO OKAZAKI, Shiga (JP); YU KANEDA, Nara (JP); KAZUKI ISHIKAWA, Kyoto (JP)

(21) Appl. No.: 19/200,768

(22) Filed: May 7, 2025

Related U.S. Application Data
(63) Continuation of application No. PCT/JP2023/040766, filed on Nov. 13, 2023.

(30) Foreign Application Priority Data
Nov. 28, 2022 (JP) 2022-189109

(51) Int. Cl. B25J 15/00

(52) U.S. Cl. CPC B25J 15/0033

(57) ABSTRACT

A gripping device includes a base and a plurality of gripping parts provided on the base, the plurality of gripping parts being configured to grip an object, wherein the plurality of gripping parts include a plurality of surface portions having different properties.

### TECHNICAL FIELD

The present disclosure relates to a gripping device.

### BACKGROUND ART

There has conventionally been known a gripping device including a plurality of gripping part for gripping an object (see, for example, PTL 1).

### CITATION LIST

### Patent Literature

PTL 1: Unexamined Japanese Patent Publication No. 2016-30316

### SUMMARY OF THE INVENTION

However, the configuration of the conventional technology does not correspond to various objects because the gripping surface of the gripping part is uniform, and the contact property with respect to the objects is constant.

An object of the present disclosure is to provide a gripping device capable of gripping various objects.

A gripping device according to the present disclosure includes:
a base; and
a plurality of gripping parts provided on the base, the plurality of gripping parts being configured to grip an object,
in which the plurality of gripping parts include a plurality of surface portions having different properties.

According to the present disclosure, various objects can be gripped.

### BRIEF DESCRIPTION OF THE DRAWINGS

FIG. 1A is a diagram illustrating a schematic configuration of a robot device including a gripping device according to an exemplary embodiment of the present disclosure.

FIG. 1B is a diagram illustrating a schematic configuration of the robot device including the gripping device according to the exemplary embodiment of the present disclosure.

FIG. 2 is a diagram illustrating the gripping device according to the present exemplary embodiment.

FIG. 3A is a diagram for describing switching of a surface member at a gripping part of the gripping device.

FIG. 3B is a diagram for describing switching of the surface member at the gripping part of the gripping device.

FIG. 4 is a diagram for describing a relationship between the forces acting on the gripping part of the gripping device.

FIG. 5 is a diagram illustrating an example of gripping with a gripping device according to a modification in which each surface member has a different thickness.

FIG. 6A is a diagram for describing switching of the surface member at a gripping part of the gripping device according to the modification illustrated in FIG. 5.

FIG. 6B is a diagram for describing switching of the surface member at the gripping part of the gripping device according to the modification illustrated in FIG. 5.

FIG. 7 is a diagram illustrating a gripping device according to a modification in which each surface member has a different shape.

FIG. 8 is a diagram illustrating an example of the shape of the surface member in the modification illustrated in FIG. 7.

FIG. 9 is a diagram illustrating an example of the shape of the surface member in the modification illustrated in FIG. 7.

FIG. 10 is a diagram illustrating an example of the shape of the surface member in the modification illustrated in FIG. 7.

FIG. 11A is a diagram illustrating an example of the shape of the surface member in the modification illustrated in FIG. 7.

FIG. 11B is a diagram illustrating an example of gripping with the surface member in the modification illustrated in FIG. 11A.

FIG. 12 is a diagram illustrating an example of gripping with a gripping device according to a modification in which each surface member has a different stretchability.

FIG. 13 is a diagram illustrating an example of gripping with a gripping device according to a modification in which each surface member has a different flexibility.

FIG. 14 is a diagram illustrating an example of gripping with a gripping device according to a modification in which each surface member has a different water resistance.

FIG. 15 is a diagram illustrating an example of gripping with a gripping device according to a modification in which each gripping part has a different surface member.

FIG. 16 is a diagram illustrating an example of gripping with a gripping device according to a modification in which different surface members are arranged in a width direction of a belt.

FIG. 17 is a diagram illustrating a modification of the disposition of surface members.

FIG. 18 is a diagram illustrating a modification including no belt. FIG. 19 is a diagram illustrating a belt of a gripping device according to a modification.

### DESCRIPTION OF EMBODIMENT

### Exemplary Embodiment

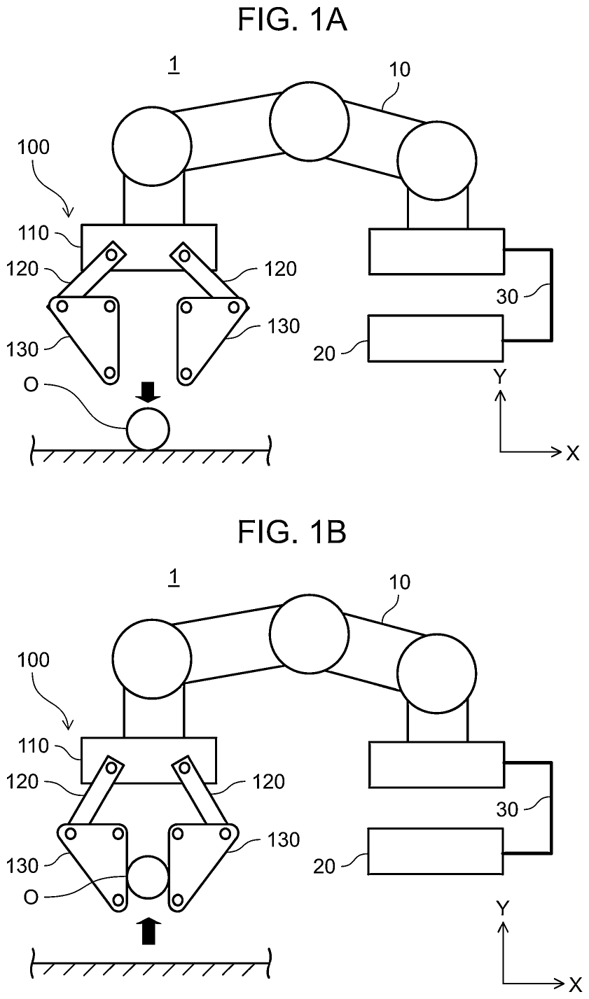

Hereinafter, an exemplary embodiment of the present disclosure will be described in detail with reference to the drawings. FIGS. 1A and 1B are diagrams illustrating a schematic configuration of robot device 1 including gripping device 100 according to an exemplary embodiment of the present disclosure. In the description of FIG. 1A and the like, an orthogonal coordinate system (X, Y) is used. The drawings described later are also illustrated with a common orthogonal coordinate system (X, Y). For example, an X direction indicates a left-right direction, and a Y direction indicates an up-down direction.

As illustrated in FIGS. 1A and 1B, robot device 1 is a robot device imitating a human hand, such as an industrial robot, and it has a function of gripping object O disposed at a predetermined place and conveying object O to another place. Robot device 1 includes robot arm 10, controller 20, and gripping device 100.

Robot arm 10 is, for example, a vertical articulated robot, a scalar robot, or the like, having a proximal end fixed to a stage or the like and a distal end connected to gripping device 100 capable of gripping object O. Robot arm 10 is configured to be able to move gripping device 100 in any directions such as up, down, left, right, front, back, and the like.

Controller 20 includes a central processing unit (CPU), a read only memory (ROM), a random access memory (RAM), and an input/output circuit (not illustrated). Controller 20 transmits a control signal to robot arm 10 and gripping device 100 via cable 30 to control the operations of robot arm 10 and gripping device 100.

Gripping device 100 is a device for gripping object O, including base 110, link 120, and a pair of gripping parts 130.

Base 110 is a portion attached to the distal end of robot arm 10. Link 120 is a link mechanism that connects base 110 and the pair of gripping parts 130. One link is provided corresponding to each of the pair of gripping parts 130. Link 120 is configured to be able to perform an opening/closing operation of moving each gripping part 130 close to or away from each other with a drive mechanism (not illustrated) to which torque is transmitted from an actuator or the like.

FIG. 1A illustrates a state in which gripping parts 130 are opened by links 120 to grip object O. FIG. 1B illustrates a state in which gripping parts 130 are closed by links 120 and gripping object O.

The pair of gripping parts 130 face each other in the X direction, and they are portions that grip object O by sandwiching object O therebetween.

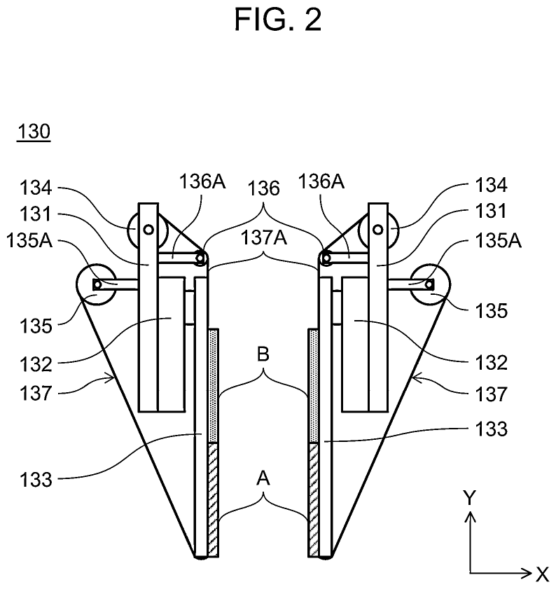

As illustrated in FIG. 2, gripping part 130 includes main body 131, linear motion part 132, spatula 133, belt connection 134, pulling part 135, guide roller 136, and belt 137.

Gripping parts 130 have the same configuration, and in the following description, unless otherwise specified, gripping part 130 positioned on the −side in the X direction will be described, and gripping part 130 positioned on the +side in the X direction will not be described. In addition, since gripping parts 130 are disposed symmetrically in the X direction, the relationship between the +side and the −side in the X direction in gripping part 130 positioned on the +side in the X direction is opposite to the relationship between the +side and the −side in the X direction in the gripping part 130 positioned on the −side in the X direction.

Main body 131 is a component constituting a main body part of gripping part 130. Main body 131 is formed in, for example, a plate shape, and it is disposed along the Y direction in the present exemplary embodiment. Linear motion part 132 is attached to main body 131 on the +side in the X direction. Spatula 133 is attached to linear motion part 132 on +side in the X direction.

Linear motion part 132 is a linear motion device (for example, a rack-and-pinion mechanism) for linearly moving spatula 133 in a direction along main body 131. The linear motion part is operated by a motor or the like, not illustrated, to linearly move spatula 133 under the control of controller 20.

Spatula 133 is a member formed in a thin plate shape and is movable in a direction along main body 131 with linear motion part 132. Spatula 133 is disposed on the +side in the X direction with respect to linear motion part 132 and is sandwiched between linear motion part 132 and belt 137.

Linear motion part 132 moves spatula 133, and the position of the tip of gripping part 130 can be changed in the Y direction to change the length of gripping part 130. Linear motion part 132 and spatula 133 do not have to be provided.

Belt connection 134 is a roller member connected to one end of belt 137 and is provided at the +side end of main body 131 in the Y direction. Belt connection 134 is configured to be rotatable with a motor (not illustrated) under the control of controller 20. When belt connection 134 rotates forward or backward, belt 137 is wound around belt connection 134 or fed from belt connection 134.

Pulling part 135 is a roller member to which the other end of belt 137 is connected. The pulling part pulls belt 137 toward the winding side with a flat spiral spring (not illustrated). Pulling part 135 is rotatably supported by a support 135A protruding from the-side surface of main body 131 in the X direction.

Guide roller 136 is a roller member that guides the movement of belt 137. The guide roller is rotatably supported by support 136A protruding from the +side surface of main body 131 in the X direction.

Belt 137 has an antagonistic structure in which one end is connected to belt connection 134 and the other end is connected to pulling part 135. The belt is disposed so as to surround main body 131, linear motion part 132, and spatula 133. Specifically, belt 137 is disposed to be stretched around belt connection 134, guide roller 136, the tip of spatula 133, and pulling part 135.

A tension can be applied to belt 137 by disposing a motor on belt connection 134 side and a flat spiral spring on pulling part 135, for example. For example, when the motor is driven in the direction in which belt 137 is wound around belt connection 134 with a force larger than the elastic force of the flat spiral spring by the motor control, a tension difference is generated in the direction, and belt 137 is wound around belt connection 134. When the motor is driven in the winding direction with a force smaller than the elastic force of the flat spiral spring, a tension difference is generated in the direction in which belt 137 is fed from belt connection 134, and belt 137 is fed from belt connection 134.

On a surface of belt 137, that is, gripping surface 137A which is the surface of belt 137 on the side gripping object O, two surface members A and B made of different materials are disposed side by side in the Y direction (direction from base 110 toward the tip of gripping part 130). In other words, the pair of gripping parts 130 include a plurality of surface portions having different properties.

Surface members A and B may be bonded to belt 137 with an adhesive or the like.

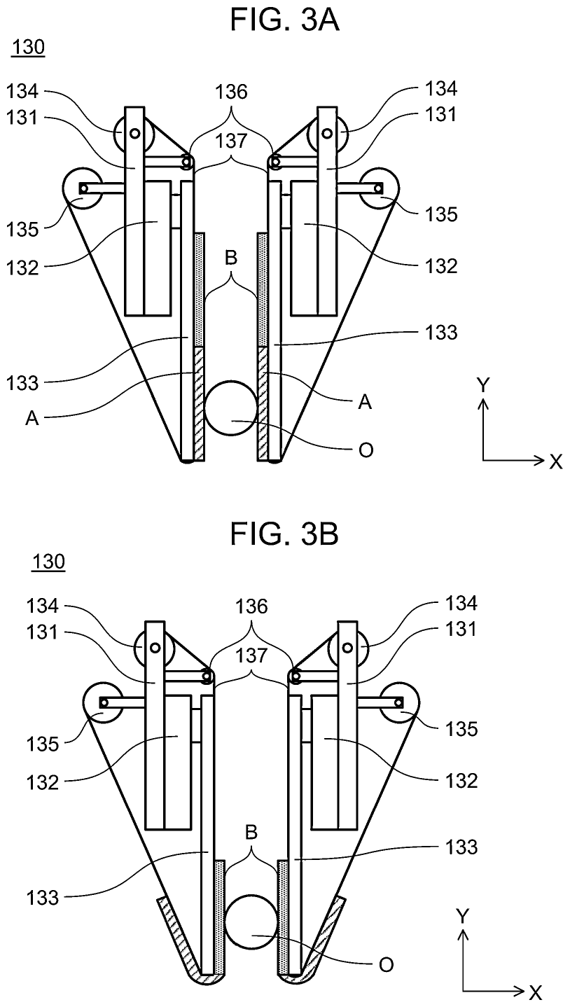

In the present exemplary embodiment, the position of gripping part 130 to grip object O is the tip of gripping part 130, that is, the end on the −side of the gripping surface of the belt 137 in the Y direction. Thus, as illustrated in FIG. 3A, when object O is gripped by the portion of surface member A, the rotation of belt connection 134 that winds belt 137 is controlled such that the portion of surface member A comes at a position corresponding to the −side end in the Y direction. As illustrated in FIG. 3B, when object O is gripped by the portion of surface member B, the rotation of belt connection 134 is controlled such that the portion of surface member B comes at a position corresponding to the +side end in the Y direction.

In other words, gripping part 130 is configured to be able to switch the positions of the plurality of surface portions with the movement of belt 137 such that at least one of the plurality of surface portions becomes the gripping position for object O.

For example, each of the plurality of surface portions may have a different hardness.

Here, it is assumed that surface member A is made of a relatively hard material, and surface member B is made of a softer material having a cushioning property and being deformable than surface member A. In this case, when object O is an object that easily breaks such as a fragile object, surface member B that can wrap object O in a relatively wide range by deforming is preferably disposed at the gripping position.

When it is desired to accurately position object O at a conveyance destination, there is a possibility that accurate positioning cannot be performed when the gripping position deforms. In such a case, surface member A made by a relatively hard material is preferably disposed at the gripping position.

The contact property of gripping part 130 with respect to object O can be changed in accordance with object O by selectively switching the surface portions having different properties as the gripping position of gripping part 130. As a result, object O can be stably gripped by gripping device 100, and the performance of work execution in gripping device 100 can be improved.

In addition, by moving belt 137, the gripping position of gripping part 130 can be easily switched.

The displacement amount of belt 137 can be detected from, for example, a rotation angle of the motor that drives belt 137 obtained from a rotation angle sensor such as an encoder, a reduction ratio of the drive mechanism, a diameter of the pulley that winds the belt, and the like. The detection of the displacement amount is not limited to this configuration, and the displacement amount of belt 137 can be detected by measuring a rotation angle on the flat spiral spring (pulling part 135) side. Belt 137 is movable in the Y direction, but it may be movable in other directions (X direction or the like).

Next, a specific example of the plurality of surface portions having different properties in belt 137 will be described.

For example, each of the plurality of surface portions may have a different friction coefficient.

For example, it is assumed that the material of surface member A is a material having a relatively large friction coefficient such as an anti-slip rubber, and the material of surface member B is a material having a friction coefficient smaller than that of surface member A, such as a Teflon (registered trademark) tape or a PET film.

When object O is an object having a slippery surface, and the gripping surface of gripping part 130 has a small friction coefficient, object O slides on the gripping surface of gripping part 130, and object O is hardly gripped. Thus, it is necessary to increase the force for sandwiching object O with gripping parts 130.

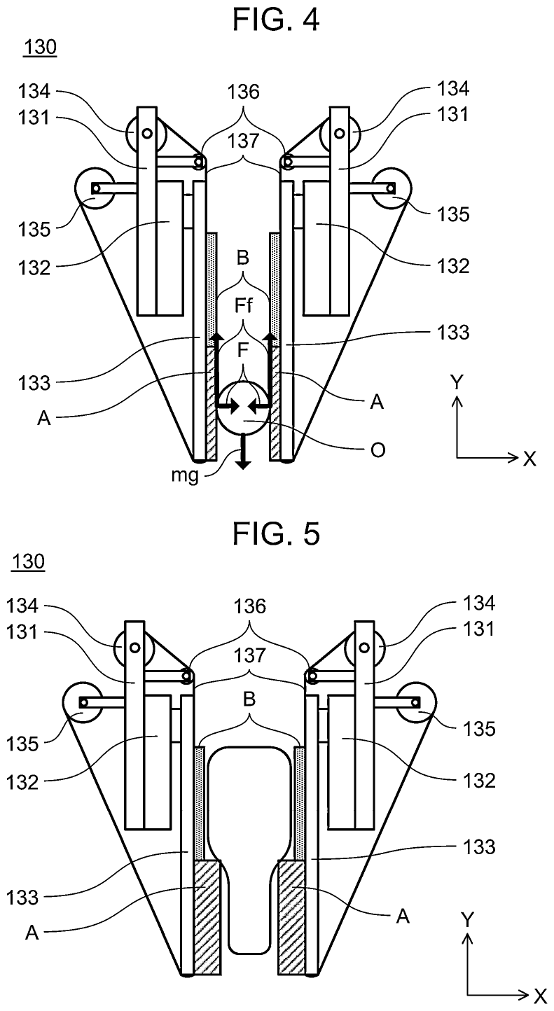

As illustrated in FIG. 4, frictional force Ff in a direction opposite to the gravity direction (direction toward the +side in the Y direction) and gripping force F, which is a normal force at a contact point between the gripping surface and object O, act between object O gripped by gripping part 130 and the gripping surface. As the condition that object O gripped by grip part 130 does not slide off, frictional force Ff when object O is gripped by gripping part 130 needs to be larger than mg (m: weight of object O, g: gravitational acceleration) that is the gravity of object O.

When object O is gripped by two gripping parts 130, gravity mg of object O is held by the frictional force of two gripping parts 130. Thus, the condition that object O does not slide off is Ff>0.5 mg. Ff is a value (Ff=μ×F) obtained by multiplying gripping force F, which is a normal force, by friction coefficient u between the gripping surface and object O.

That is, the condition that object O does not slide off is μ×F>0.5 mg. Thus, when friction coefficient u between the gripping surface and object O is relatively small, it is necessary to increase gripping force F. In this case, when object O is a fragile object, there is a possibility that object O is destroyed, or object O is deformed by gripping force F.

Thus, when object O is a fragile object or an object having a slippery surface, to avoid applying a large gripping force to object O, surface member A having a relatively large friction coefficient is preferably employed at the gripping position of gripping part 130.

When object O is an object having a surface that is difficult to slip, and the gripping position of gripping part 130 has a large friction coefficient, the gripping surface and object O remain attached when object O is released from grip part 130, and there is a risk that object O cannot be appropriately disposed at a conveyance destination.

Thus, when object O is an object having a surface that is difficult to slip, surface member B having a relatively small friction coefficient is preferably employed at the gripping position of gripping part 130.

As a result, the friction coefficient at the gripping position can be made variable, which is useful when both slippery object O and other objects O need to be conveyed.

For example, each of the plurality of surface portions may have a different thickness.

For example, as illustrated in FIG. 5, it is assumed that the thickness of surface member A is larger than the thickness of surface member B. In this case, for example, when object O having a diameter that changes in the Y direction, such as a bottle, is gripped, a portion having a small diameter of object O is gripped by surface member A, and a portion having a large diameter of object O is gripped by surface member B, whereby object O can be stably gripped.

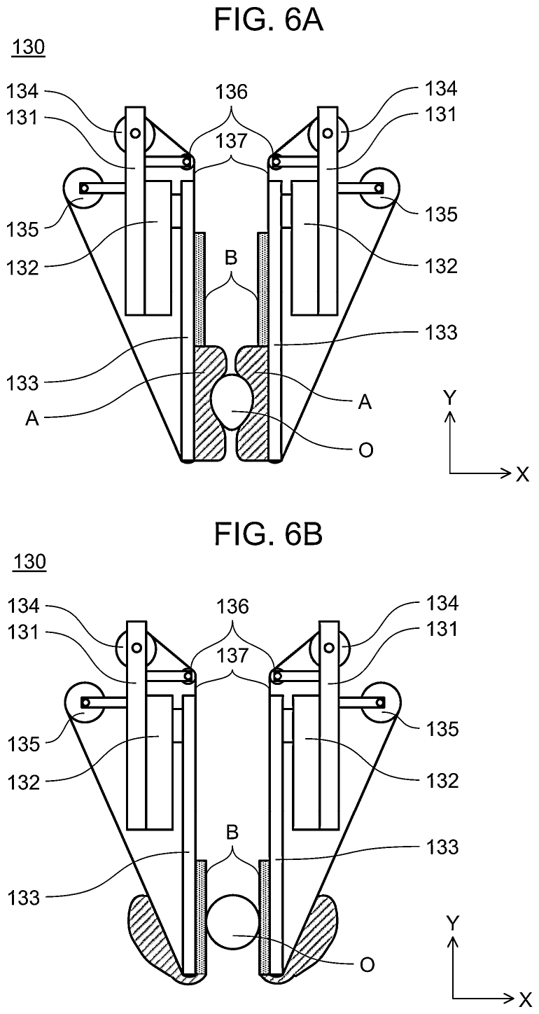

For example, as illustrated in FIGS. 6A and 6B, it is assumed that surface member B is a relatively thin member such as one piece of cloth, and surface member A is a member thicker than surface member B, such as a cushion in which a batting is sandwiched between pieces of cloth.

As illustrated in FIG. 6A, when object O is an object that easily breaks such as a raw egg, object O is less likely to break when gripped in such a manner that object O is wrapped with a member having a certain thickness rather than gripped in point contact with a thin member. In this case, surface member A having a large thickness is preferably employed at the gripping position of gripping part 130.

As illustrated in FIG. 6B, when object O is an object that hardly breaks, it is easy to stably hold object O in point contact. Thus, in this case, surface member B having a small thickness is preferably employed at the gripping position of gripping part 130.

As a result, the thickness at the gripping position can be made variable, which is useful when it is necessary to convey both object O to be gripped in a wrapped manner with a thick member and other objects O.

Further, for example, each of the plurality of surface portions may have a different shape.

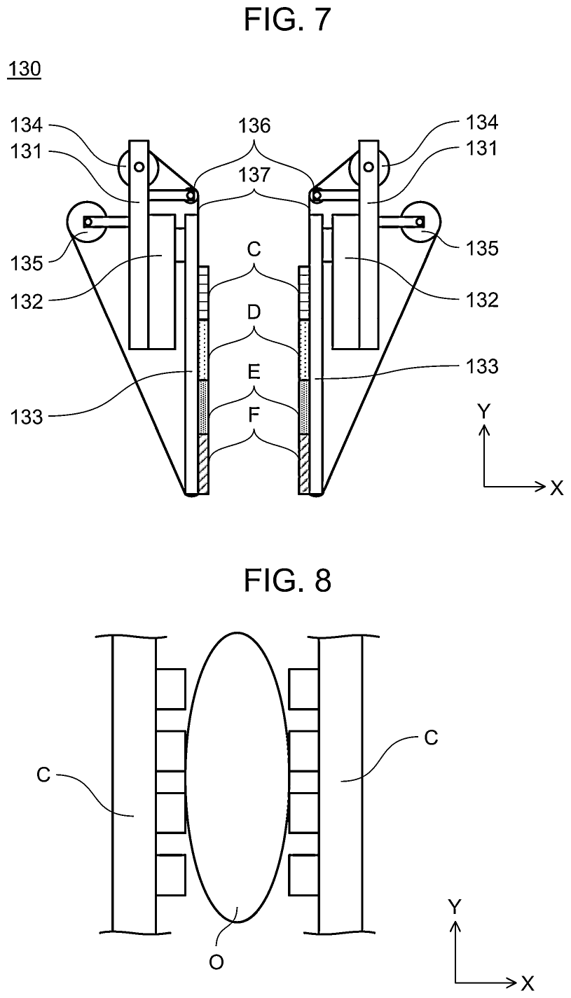

For example, as illustrated in FIG. 7, it is assumed that belt 137 is provided with four surface members C, D, E, and F having different properties. Surface members C, D, E, and F are disposed in this order in the direction from belt connection 134 toward pulling part 135.

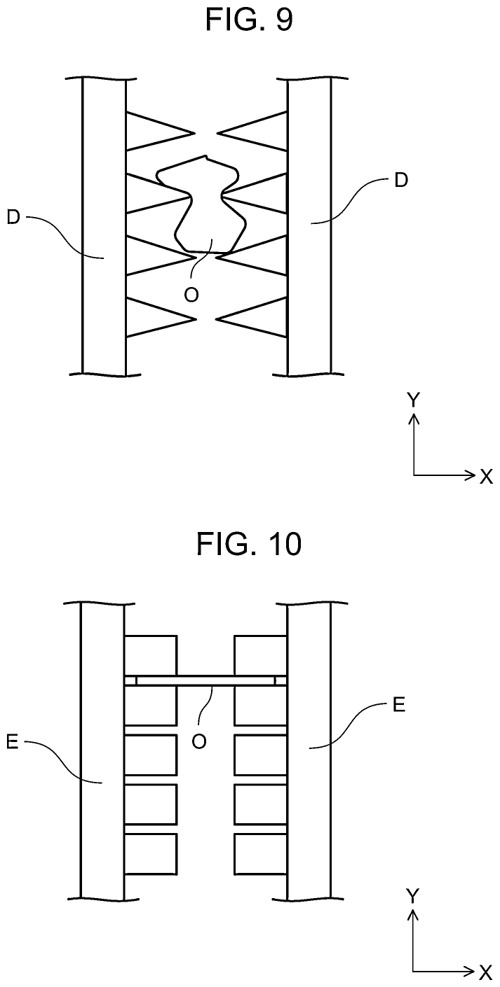

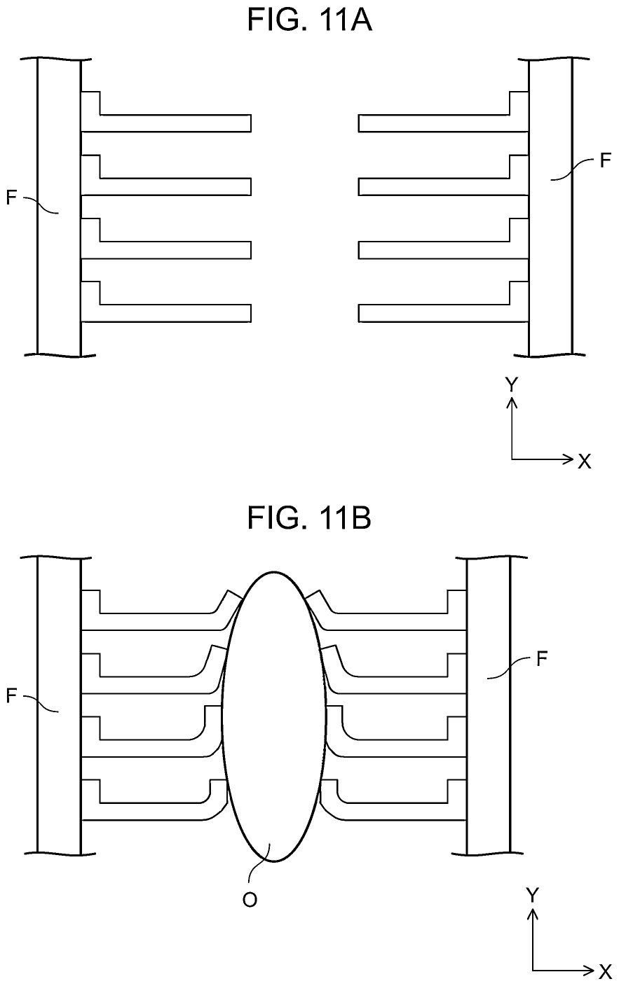

In surface member C, a plurality of projections having a columnar shape is uniformly disposed (see FIG. 8). In surface member D, a plurality of projection having a triangular sectional shape and extending in a width direction (direction perpendicular to the X direction and the Y direction) of belt 137 are disposed in the Y direction (see FIG. 9). In surface member E, a plurality of grooves extending in the width direction of belt 137 are formed (see FIG. 10). In surface member F, a plurality of bendable and deformable projections extending in the width direction of belt 137 are formed (see FIGS. 11A and 11B).

As illustrated in FIG. 8, when a gripping position of gripping part 130 is a surface member C, object O can be gripped in point contact by each projection. Thus, when object O is a relatively hard object, surface member C is preferably employed at the gripping position of gripping part 130.

As illustrated in FIG. 9, when a gripping position of gripping part 130 is surface member D, object O having an uneven shape can be hooked and gripped between the triangular projections. Thus, when object O is an object having an uneven shape, surface member D is preferably employed at the gripping position of gripping part 130.

As illustrated in FIG. 10, when a gripping position of gripping part 130 is surface member E, object O having a thin plate shape, such as a prepared slide of a microscope, can be gripped in a groove portion. Thus, when object O is a thin plate-shaped object, surface member E is preferably employed at the gripping position of gripping part 130.

As illustrated in FIGS. 11A and 11B, when a gripping position of gripping part 130 is surface member F, surface member F can grip object O in a state of having a cushioning property with the plurality of projections being bent and deformed. Thus, the surface member can grip object O with a softer contact property than a material that does not bend or deform. Thus, when object O is a fragile object, an object that easily breaks, or the like, surface member F is preferably employed as the gripping position of gripping part 130.

As a result, the shape at the gripping position can be made variable, which is useful when it is necessary to convey objects O having various shapes.

Further, for example, each of the plurality of surface members may have a different stretchability.

For example, it is assumed that the material of surface member A has stretchability, and it is easily stretch, and the material of surface member B is less stretchable than surface member A. The presence or absence of stretchability in the surface member may be determined by, for example, the magnitude of the shear elastic coefficient.

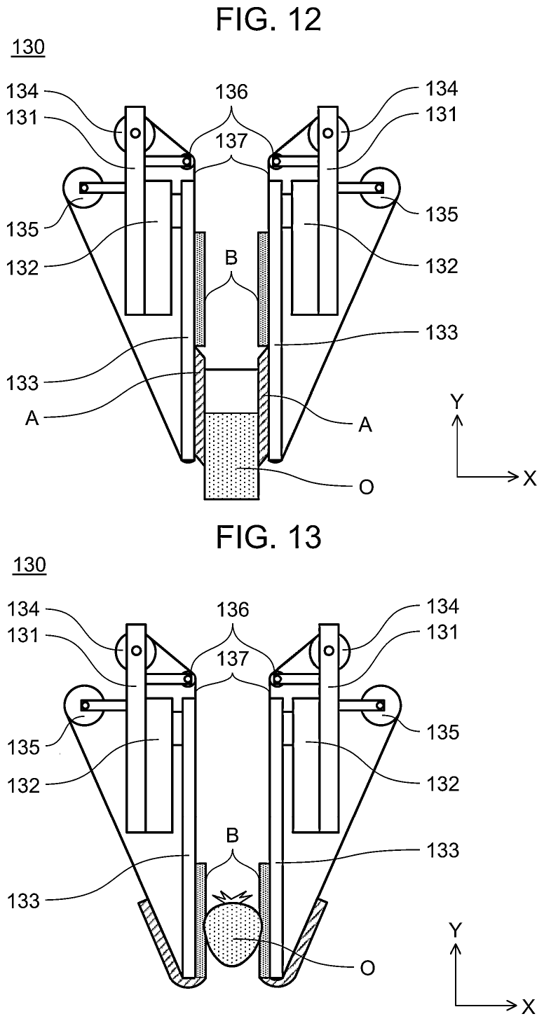

As illustrated in FIG. 12, when object O is, for example, a cup containing water, the water in the cup may be spilled when object O is moved in the Y direction. In this case, when surface member A having stretchability is used, surface member A deforms to the −side in the Y direction. Specifically, surface member A undergoes shear deformation because of gravity acting on object O while the contact point of surface member A with object O is maintained. That is, when surface member A undergoes shear deformation, the inertial force applied to object O can be absorbed. In this case, surface member A having stretchability is preferably employed at the gripping position of gripping part 130.

When object O is not the above-described object, the object can be stably gripped when object O is gripped in point contact. Thus, in this case, surface member B having no stretchability is preferably employed at the gripping position of gripping part 130.

As a result, the stretchability at the gripping position can be made variable, which is useful when it is necessary to convey both object O such as a cup containing water and other objects O.

Further, for example, each of the plurality of surface portions may have a different flexibility.

For example, it is assumed that the material of surface member A is a hard material having no flexibility, and the material of surface member B is a soft material more flexible than surface member A. The presence or absence of flexibility may be determined by, for example, a compressive elasticity modulus in the directions (X direction) of sandwiching the object with gripping parts 130.

As illustrated in FIG. 13, when object O is a fragile object such as fresh strawberry, it is necessary to convey object O without damaging object O when conveying object O. In this case, when object O is gripped by surface member A made of a hard material, object O may be damaged. In this case, surface member B having flexibility is preferably employed at the gripping position of gripping part 130.

When object O is not the above-described object, the object can be stably gripped when object O is gripped in point contact. Thus, in this case, surface member B having no flexibility is preferably employed at the gripping position of gripping part 130.

As a result, the flexibility at the gripping position can be made variable, which is useful when it is necessary to convey both object O that is a fragile object and other objects O.

Further, for example, each of the plurality of surface portions may have a different water resistance.

For example, it is assumed that the material of surface member A is a material having water resistance, and the material of surface member B is a material having less water resistance than surface member A. The presence or absence of water resistance may be determined by, for example, checking whether liquid is repelled on the surface, or the ease of permeation of liquid.

When object O is a wet object such as a food material, surface member A formed of a material having water resistance is preferably employed at the gripping position of gripping part 130. When object O is a non-wet object other than a food material, surface member B formed of a material having no water resistance is preferably employed at the gripping position of gripping part 130.

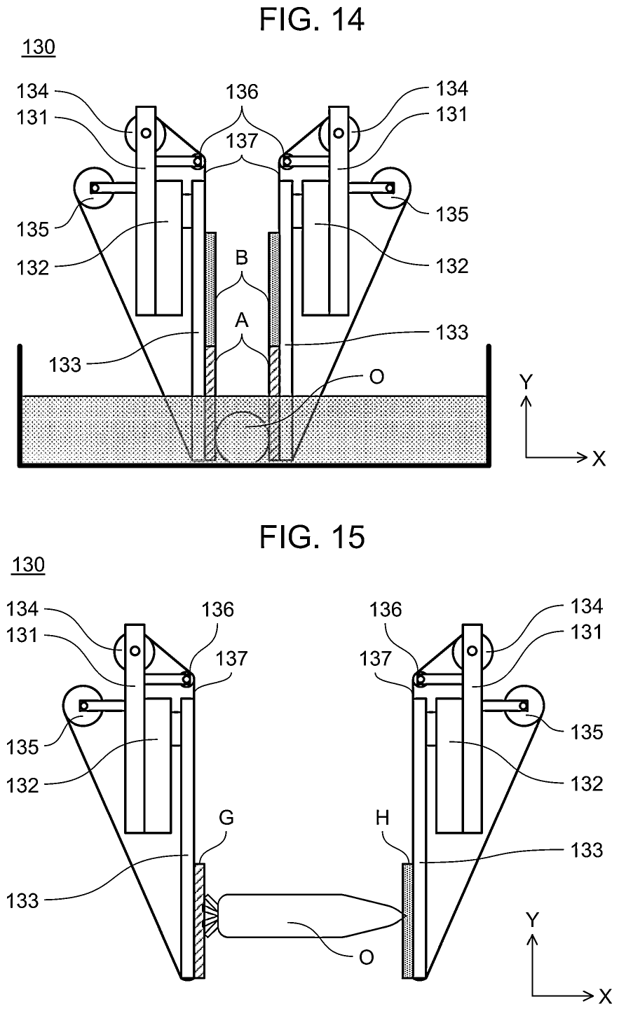

As illustrated in FIG. 14, for example, when object O is in a water tank containing liquid, surface member A formed of a material having water resistance is preferably employed at the gripping position of gripping part 130 to grip object O.

As a result, the water resistance at the gripping position can be made variable, which is useful when both wet object O and non-wet object O need to be conveyed.

When gripping part 130 needs to be placed in a water tank, and surface member A is positioned at the gripping position in gripping part 130, the surface members may be disposed such that surface member B having no water resistance is positioned above surface member A (+side in the Y direction). This can prevent surface member B from wetting.

According to the present exemplary embodiment configured as described above, gripping part 130 has a plurality of surface portions having different properties. Thus, switching to a portion having the property corresponding to gripping of object O can be performed. As a result, various objects O can be gripped.

In the above-described exemplary embodiment, the pair of gripping parts 130 grips object O with portions having the same property as the gripping positions, but the present disclosure is not limited to this configuration. Object O may be gripped with portions having different properties as the gripping positions. In other words, each of the surface portions of the pair of gripping parts 130 may have a different property.

For example, as illustrated in FIG. 15, it is assumed that surface member G is provided on the gripping surface of gripping part 130 on the −side in the X direction, and surface member H is provided on the gripping surface of gripping part 130 on the +side in the X direction.

For example, it is assumed that object O is a Japanese radish whose one side is a wet portion like a leaf and the other side is a pointed portion.

Surface member G is made of, for example, a water-resistant material, and surface member H is made of a cushioning material. In the case of the present example, the gripping surface of one (−side in the X direction) of gripping parts 130 has surface member G having one property. The gripping surface of the other (+side in the X direction) gripping part 130 has surface member H also having one property. Such a configuration may also be understood that the plurality of gripping parts have a plurality of surface portions having properties different from each other.

With this configuration, a Japanese radish can be gripped by applying surface member G to the leaf portion of the Japanese radish and applying surface member H to the pointed portion of the Japanese radish. As a result, the Japanese radish can be appropriately gripped.

In such a configuration, the gripping position of gripping part 130 can be selectively changed in accordance with the position of object O to be gripped.

In the configuration illustrated in FIG. 15, one surface member is provided for each of gripping parts 130, but the present disclosure is not limited to this configuration.

Two or more surface members may be provided for each of gripping parts 130. In the configuration illustrated in FIG. 2 and the like, belt 137 of each of gripping parts 130 may be controlled to cause the surface members having properties different from each other to face each other.

In the above-described exemplary embodiment, the plurality of surface members (plurality of surface portions) having properties different from each other are arranged in the Y direction, but the present disclosure is not limited to this configuration. For example, the plurality of surface members may be arranged in the width directions (the directions perpendicular to the X direction and the Y direction) of gripping part 130.

For example, as illustrated in FIG. 16, it is assumed that surface members I and J arranged in the width directions are provided on the gripping surface of gripping part 130.

For example, it is assumed that object O is an object in which portions having different diameters are mixed in the width direction of gripping part 130 like a container in which a lid is attached to a main body.

In this case, in surface members I and J arranged in the width direction, for example, surface member I is a member having a large thickness, and surface member J is a member having a small thickness.

As described above, object O in which portions having different diameters are mixed is gripped by gripping part 130 having members having different thicknesses in the width direction. With this configuration, for example, the lid portion and the main body portion of a PET bottle lying on the ground are gripped by gripping part 130 from directly above, and the respective surface members can be gripped in close contact.

For example, in a configuration in which the surface members are not arranged in the width direction, it is difficult to bring the gripping surface into close contact with entire object O when gripping object O having unevenness such as a container in which a lid is attached to a main body. In particular, in a configuration in which the gripping surface of the gripping part moves only in parallel like a parallel gripper, the orientation of the gripping part cannot be changed, and thus it is more difficult to bring the gripping surface into close contact with entire object O having unevenness.

On the other hand, with the configuration illustrated in FIG. 16, even object O having unevenness can be gripped while the gripping surface is brought into close contact with entire object O.

In the above-described exemplary embodiment, the configuration in which a plurality of surface members are arranged side by side in the Y direction, the configuration in which the plurality of surface members are arranged in the width direction, and the like are exemplified. However, a configuration in which a portion in which a plurality of surface members are arranged in the Y direction and a portion in which a plurality of surface members are arranged in the width direction are mixed may also be employed.

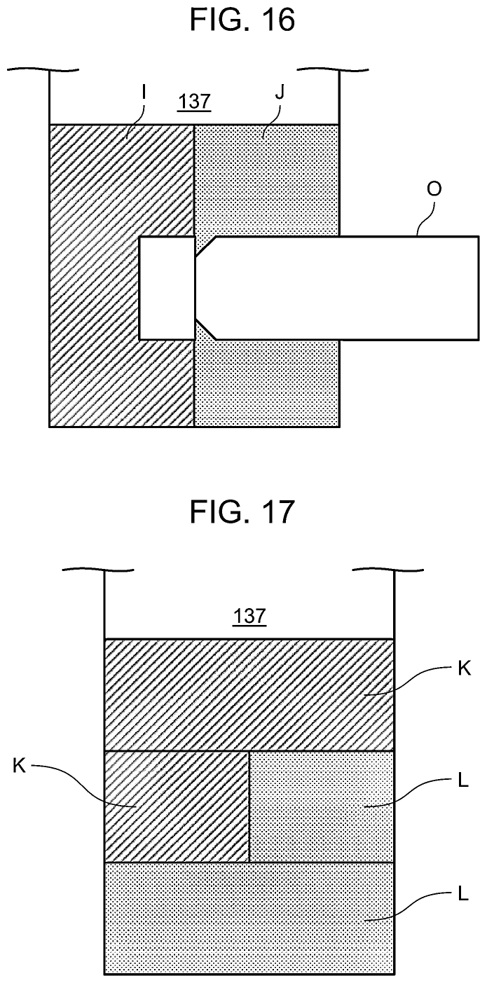

For example, FIG. 17 illustrates a configuration in which, in belt 137, a portion of only surface member K, a portion in which surface member K and surface member L are arranged in the width direction, and a portion of only surface member L are arranged in this order from the +side in the Y direction. Surface members K and L have properties different from each other.

With such a configuration, for object O having unevenness in the width direction as illustrated in FIG. 16, the portion where surface member K and surface member L are arranged in the width direction can be set as the gripping position, and for another object O, the portion of only surface member K or the portion of only surface member L can be set as the gripping position. As a result, it is possible to obtain gripping device 100 corresponding to various objects O.

In the above-described exemplary embodiment, the gripping part includes the belt, but the present disclosure is not limited to this configuration. The gripping part may include no belt. As a configuration including no belt, a configuration in which the position of the surface member is fixed in the gripping part may be employed. For example, a configuration in which the position of the surface member is fixed to the gripping part can be applied for a configuration having different surface members in the width direction of the gripping part illustrated in FIG. 16, a configuration having different surface members in each gripping part illustrated in FIG. 15, and the like.

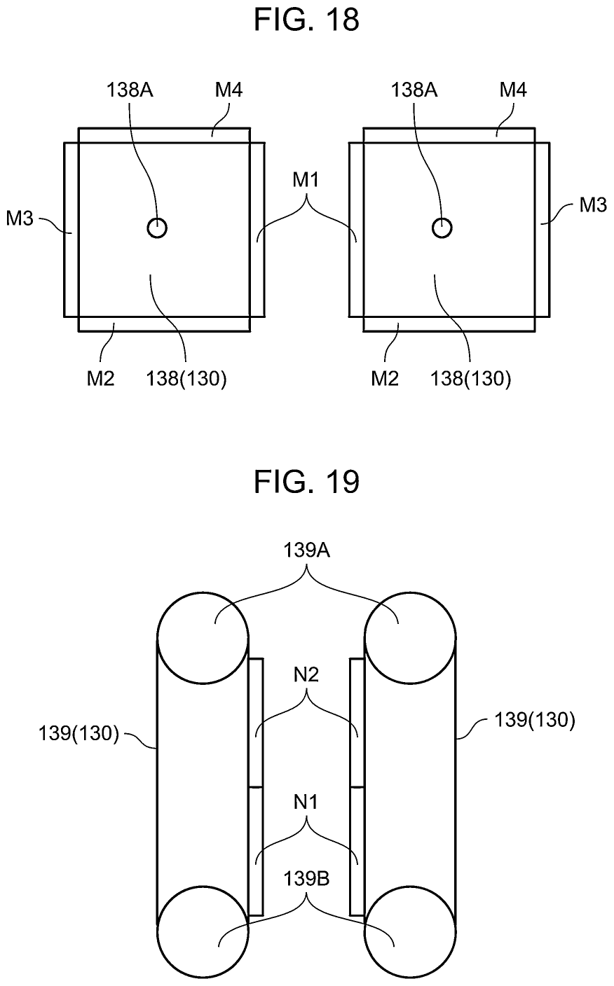

As a configuration in which the gripping part includes no belt, as illustrated in FIG. 18, gripping part 130 may have rotary member 138 that is rotatable. Rotary member 138 is a member that rotates about rotary shaft 138A. Rotary member 138 is configured to have a plurality of surfaces having a polygonal sectional shape (quadrangular in FIG. 18), and it has rotary shaft 138A at the center thereof.

Surface members M1, M2, M3, and M4 having different properties are respectively provided on the surfaces of each rotary member 138. With such a configuration as well, the surface member of the facing surface of each gripping part can be selectively switched by rotating each rotary member 138 about rotary shaft 138A. Rotary shaft 138A may be parallel to a direction orthogonal to the XY plane or may be parallel to the Y direction.

In the above-described exemplary embodiment, the surface member is provided on the gripping surface, but the present disclosure is not limited to this configuration. The surface member may have a gripping surface integrally formed.

In the above-described exemplary embodiment, the belt is configured to be stretched between belt connection 134 and pulling part 135, but the present disclosure is not limited to this configuration. An endless belt may be provided.

For example, FIG. 19 illustrates a configuration in which gripping part 130 includes endless belt 139. Belt 139 is provided by bridging drive roller 139A that rotates with driving and driven roller 139B. Surface members N1 and N2 having different properties are provided on the surface of belt 139.

With such a configuration as well, the surface member of the facing surface of each gripping part may be selectively switched by rotating belt 139.

In the above-described exemplary embodiment, a pair of gripping parts is provided, but the present disclosure is not limited to this configuration. Three or more gripping parts may be provided.

The above exemplary embodiment only shows a specific example of exemplary embodiments of the present disclosure. Therefore, it should not be understood that the above exemplary embodiment limits a technical scope of the present disclosure. That is, the present disclosure is applied in various forms without departing from a spirit of the present disclosure or essential features of the present disclosure.

### INDUSTRIAL APPLICABILITY

The gripping device of the present disclosure is useful as a gripping device capable of gripping various objects.

### REFERENCE MARKS IN THE DRAWINGS

1 robot device
10 robot arm
20 controller
100 gripping device
110 base
120 link
130 gripping part
131 main body
132 linear motion part
133 spatula
134 belt connection
135 pulling part
136 guide roller
137 belt

1. A gripping device comprising:
a base; and
a plurality of gripping parts provided on the base, the plurality of gripping parts being configured to grip an object,
wherein the plurality of gripping parts include a plurality of surface portions having different properties.

2. The gripping device according to claim 1, wherein each of the plurality of surface portions has a different friction coefficient.

3. The gripping device according to claim 1, wherein each of the plurality of surface portions has a different thickness.

4. The gripping device according to claim 1, wherein each of the plurality of surface portions has a different shape.

5. The gripping device according to claim 1, wherein each of the plurality of surface portions has a different stretchability.

6. The gripping device according to claim 1, wherein each of the plurality of surface portions has a different flexibility.

7. The gripping device according to claim 1, wherein each of the plurality of surface portions has a different water resistance.

8. The gripping device according to claim 1, wherein each of the plurality of surface portions of the plurality of gripping parts has a different property.

9. The gripping device according to claim 1, wherein the plurality of surface portions are arranged in a direction from the base toward a tip of each of the plurality of gripping parts in the gripping part.

10. The gripping device according to claim 1, wherein the plurality of surface portions are arranged in a width direction of each of the plurality of gripping parts.

11. The gripping device according to claim 1, wherein each of the plurality of gripping parts is configured to switch positions of the plurality of surface portions such that at least one of the plurality of surface portions serves as a gripping position for the object.

12. The gripping device according to claim 11, wherein each of the plurality of gripping parts includes a belt member that moves to switch positions of the plurality of surface portions.
